(19) United States
(12) Patent Application Publication
(10) Pub. No.: US 2008/0208537 A1
(43) Pub. Date: Aug. 28, 2008

(54) CIRCUIT MEASURING OPERATING SPEED AND RELATED SEMICONDUCTOR MEMORY DEVICE

(75) Inventors: Jung-Bae LEE, Yongin-si (KR); Ki-Chul CHUN, Yongin-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/037,324

(22) Filed: Feb. 26, 2008

(30) Foreign Application Priority Data
Feb. 26, 2007 (KR) 10-2007-0019087

(51) Int. Cl. G06F 15/00

(52) U.S. Cl. 702/186

(57) ABSTRACT

A circuit measuring the operating speed of a semiconductor memory chip in relation to a defined asynchronous access time is disclosed. The circuit includes a test signal path extending between a test input pad and a test output pad and is formed by a plurality of test signal path segments and at least one delay element associated with at least one of the plurality of test signal path segments, such that a delay time for a test signal communicated through the test signal path is indicative of the actual asynchronous access time for the semiconductor memory chip. Each one of the plurality of test signal path segments is either an interior test signal path segment or an exterior test signal path segment.

### CROSS-REFERENCE TO RELATED APPLICATION

This application claims the benefit of Korean Patent Application No. 10-2007-0019087 filed Feb. 26, 2007, the subject matter of which is hereby incorporated by reference.

### BACKGROUND OF THE INVENTION

1. Field of the Invention

The present invention relates to a circuit measuring the operating speed of a semiconductor memory chip and a semiconductor memory chip incorporating same. More particularly, the invention relates to a circuit capable of accurately measuring the operating speed of a semiconductor memory chip during a wafer level fabrication stage and a semiconductor memory chip incorporating same.

2. Description of the Related Art

During fabrication, most semiconductor devices must have their operating speed tested before being packaged and shipped. This stage of fabrication is commonly referred to the “wafer phase” or “wafer level” since it is related to multiple semiconductor chips fabricated on a wafer before such chips are separated for packaging assembly. Wafer level testing of multiple chips in a semiconductor wafer is significantly more efficient than subsequently package level testing (i.e., testing of individually packaged devices). Thus, wafer level testing over package level testing affords improved productivity and reduced manufacturing costs.

Operating speed is one of a number of commonly tested performance parameters. It is typically defined in relation to an overall device specification. Operating speed must be tested in relation to a corresponding device specification at the wafer level since fabrication variances may result in one chip operating at a different operating speed than another chip fabricated on the same wafer. Semiconductor chips operating at a speed less than that defined by the specification can not be used, and packaging such chips would result in a waste of time and money. For this reason, the operating speed of a semiconductor chip is tested at the wafer level, and “slow” semiconductor chips are discarded or returned to quality control processes for evaluation. In contrast, semiconductor devices operating better than the defined operating speed may often be sold at a premium in the market. Such, “fast” semiconductor chips should be identified and sorted from the mix of lesser devices by wafer level testing.

One method of measuring the operating speed of a semiconductor chip at the wafer level involves the direct measurement of the operating speed. However, many contemporary semiconductor devices operate at speeds that exceed the capabilities of related test devices and equipment, so it is often impossible to conduct direct operating speed measurements. That is, many existing test devices are not able to generate a test signal at a sufficiently high frequency to test contemporary semiconductor devices, and/or are not able to receive and measure a high frequency output signal provided by the semiconductor device. For this reason, it is often necessary to measure the operating speed of a semiconductor chip indirectly using a measuring circuit that approximates (i.e., provides a representative indication of) the actual operating speed of the semiconductor chip. Such measuring circuits are commonly included within the design of the semiconductor chip for exactly this purpose.

A typical measuring circuit comprises a plurality of delay elements. A corresponding test device applies a relatively low frequency test signal to the measuring circuit input and then receives a corresponding output signal, also having a relatively low frequency, generated by the measuring circuit in response to the test signal input. A correlation formula (e.g., a weighting ratio) may be used to correlate the output signal provided by the measuring circuit with the actual operating speed of the semiconductor chip being tested. The actual operating speed indication may then be compared to the operating speed as defined by the specification. A useful correlation formula may be empirically derived using a “known-good” specimen of the semiconductor chip.

As conventionally provided, the measuring circuit has no relationship to the ultimate operation of the semiconductor device once the semiconductor chip is packaged. Accordingly, conventional measuring circuits are removed from the semiconductor die during dicing from the wafer or otherwise before packaging. As a result, conventional measuring circuits are fabricated in the peripheral regions of the semiconductor die, so that they may be readily removed prior to packaging.

Figure (FIG.) 1 is a schematic diagram of a semiconductor chip 10 incorporating a conventional measuring circuit. The measuring circuit of semiconductor chip is implemented as a plurality of operating speed correlation circuits 13 through 16 arranged around the periphery of a central die region 11. Such an arrangement is described in some additional detail, for example, in Korean Patent Document No. 505664 filed on Jan. 7, 2003, and entitled, “Semiconductor Device with Speed Binning Test Circuit for Easily monitoring Variation on Chip in Manufacturing Process and Test Method Thereof.”

Each one of the plurality of speed correlation circuits 13 through 16 of FIG. 1 comprises a delay element implemented by a predetermined number of serially connected inverters. The ratio of the delay elements in the plurality of speed correlation circuits 13 through 16 may be characterized by the expression, A:B:C:D=a:b:c:d, where “A” denotes a number obtained by subtracting 1 from the number of delay elements in a first speed correlation circuit 13, “B” denotes the number of delay elements in a second speed correlation circuit 14, “C” denotes the number of delay elements in a third speed correlation circuit 15, “D” denotes the number of delay elements in a fourth speed correlation circuit 16, and “a”, “b”, “c”, and “d” are different weighting coefficients which are, in the working example, assumed to be prime and disjoint.

First speed correlation circuit 13 delays a final delay signal to generate a first delay signal, second speed correlation circuit 14 delays the first delay signal to generate a second delay signal, third speed correlation circuit 15 delays the second delay signal to generate a third delay signal, and fourth speed correlation circuit 16 delays the third delay signal to generate the final delay circuit. The speed correlation circuits 13 through 16 are respectively connected through a plurality of I/O pads 17. Thus, the first through third delay signals and the final delay signal are respectively apparent at the plurality of I/O pads 17. This configuration allows any on chip variation (OCV) to be measured in relation to a corresponding region of the chip based on the location of a corresponding speed correlation circuit 13 to 16.

In the semiconductor die of FIG. 1, the actual operating speed is determined in relation to an asynchronous access time (tAA). The asynchronous access time represents a defined time period between receipt of an externally provided read command and a corresponding read data output. The shorter the asynchronous access time, the faster the operating speed of the semiconductor die.

Semiconductor memory devices are relatively simple in their structure, fast in their operating speed, and highly integrated relative to other types of semiconductor devices, such as System On Chip (SOC), microprocessors, etc. In order to measure the operating speed of a contemporary semiconductor memory device, a related measuring circuit having the conventional configuration described above would be very large relative to the overall size of the internal circuitry enabling the functional performance (i.e., read/write operations) of the semiconductor chip. Further, the as-fabricated structure of the components forming the measuring circuit may be markedly different from the components forming the internal circuitry of the semiconductor memory die, since the measuring circuit is completely formed in the peripheral regions of the die while the internal circuitry is formed in the central region of the die.

Given the potential for performance variances between the components forming the measuring circuit, the very large overall size of a measuring circuit, the large number of delay elements and components arranged in a measuring circuit, and the length of the connecting signal lines between the delay elements, a significant difference may exist between the actual operating speed of the semiconductor memory die and the operating speed measured by the measuring circuit. This is especially true for contemporary semiconductor memory devices which have increasingly fast operating speeds. Clearly, a more accurate approach to the measurement of actual operating speed for contemporary semiconductor memory devices is required.

### SUMMARY OF THE INVENTION

Embodiments of the invention provide a measuring circuit capable of accurately measuring the operating speed of a semiconductor memory chip. Embodiments of the invention also provide a semiconductor memory device incorporating a measuring circuit capable of accurately measuring the operating speed of the constituent semiconductor memory chip.

In one embodiment, the invention provides a circuit measuring the operating speed of a semiconductor memory chip in relation to a defined asynchronous access time, wherein the semiconductor memory chip comprises internal circuitry functionally implementing read/write operations in relation to a received command, the circuit comprising; a test signal path extending between a test input pad and a test output pad, wherein the test signal path comprises a plurality of test signal path segments and at least one delay element associated with at least one of the plurality of test signal path segments, such that a delay time for a test signal communicated through the test signal path is indicative of the actual asynchronous access time for the semiconductor memory chip, and wherein each one of the plurality of test signal path segments is either an interior test signal path segment or an exterior test signal path segment.

### BRIEF DESCRIPTION OF THE DRAWINGS

FIG. 1 is a schematic diagram illustrating a conventional semiconductor chip incorporating a measuring circuit;

FIG. 2 is a schematic diagram illustrating a semiconductor memory chip incorporating a measuring circuit according to an embodiment of the invention;

FIG. 3 is a schematic diagram illustrating a semiconductor memory chip incorporating a measuring circuit according to another embodiment of the invention; and

FIG. 4 is a schematic diagram illustrating a semiconductor memory chip incorporating a measuring circuit according to another embodiment of the invention.

### DESCRIPTION OF EMBODIMENTS

Embodiments of the invention will now be described more fully with reference to the accompanying drawings. The invention may, however, be embodied in different forms and should not be construed as limited to only the illustrated embodiments. Rather, these embodiments are presented as teaching examples. In the drawings, certain geometric relationships may be exaggerated for clarity. Throughout the drawings and written description like reference numbers and legends refer to like or similar elements.

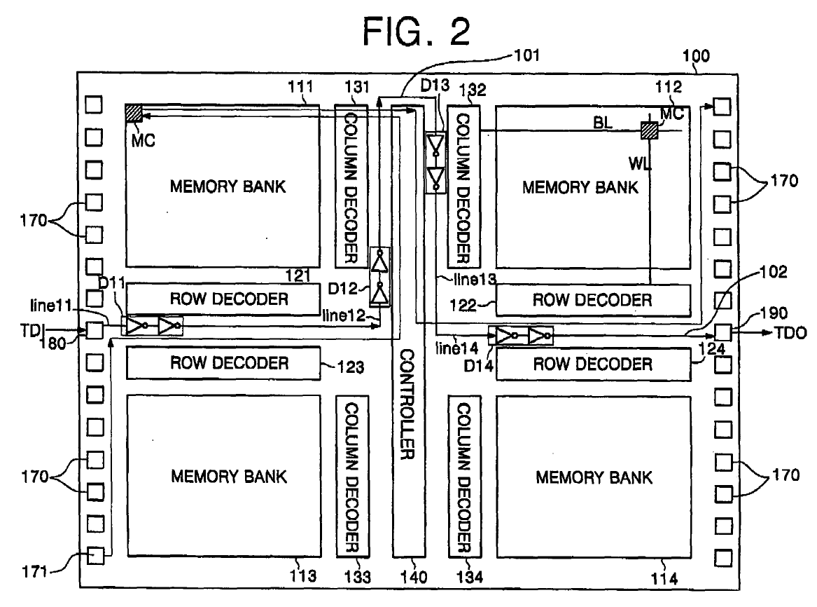

FIG. 2 is a schematic diagram illustrating a semiconductor memory chip incorporating a measuring circuit according to an embodiment of the invention. The term “chip” is used to denote a wafer level arrangement of circuits functionally enabling at least the read/write operations of the ultimately formed semiconductor memory device. Thus, a semiconductor memory chip is a wafer level fabrication of a wafer portion capable of being testing for operating speed and subsequently removed from the wafer for packaging into a semiconductor memory device.

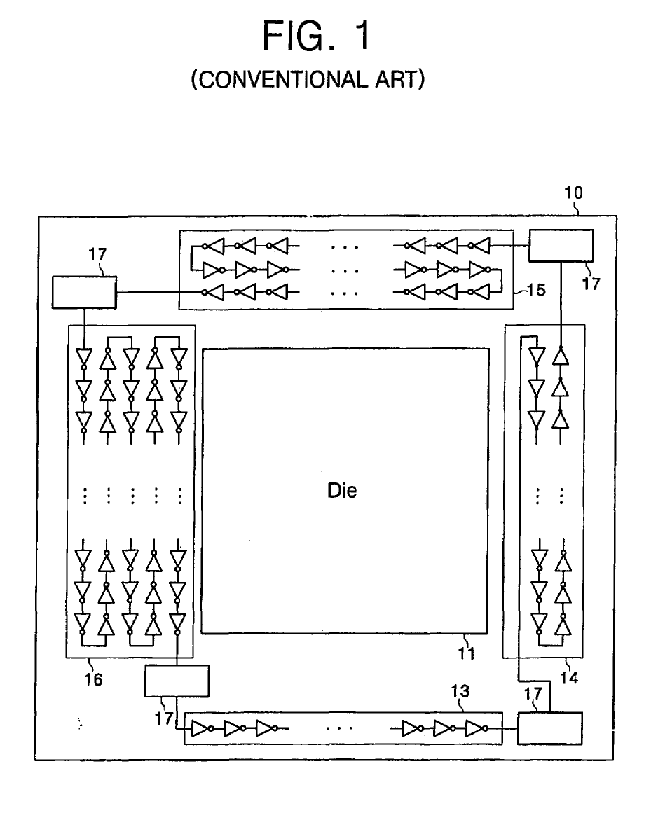

As previously noted, conventional measuring circuits, like the one illustrated in FIG. 1, have the disadvantage of being fabricated in the peripheral region of a semiconductor memory chip. The terms central and peripheral are used in relative relation to one another. Generally speaking, the “internal circuitry” of the semiconductor memory chip including at least principal circuits such as a memory bank, row and column decoders, controller, etc., are fabricated in the central portion of the chip. Whereas the conventional measuring circuit is fabrication in the surrounding peripheral region. Given center-to-peripheral region variances in the application of certain fabrication processes, it is quite possible that the conventional measuring circuit will fail to yield an accurate indication of the semiconductor memory chip's operating speed. Such inaccuracy may be due to the performance of the delay elements and length of connecting signal lines between the delay elements, etc. What ever the cause, large deviations between the measured operating speed and actual operating speed of a semiconductor memory chip have been noted in relation to the use of conventional measuring circuits. Therefore, a measuring circuit according to an embodiment of the invention, such as those illustrated in FIGS. 2, 3 and 4, have been designed to avoid such inaccuracies.

In FIG. 2, an exemplary semiconductor memory chip 100 comprises internal circuitry including a plurality of memory banks 111 to 114, a corresponding plurality of row decoder 121 to 124, a corresponding plurality of column decoders 131 to 134, and a controller 140. Each one of a plurality of memory banks 111 to 114 comprises a plurality of word lines WL and bit lines BL arranged in conventional manner. A plurality of memory cells MC is arranged at the intersections of the word lines WL and bit lines BL.

In the illustrated example it is assumed that each one of the plurality of row decoders 121 to 124 activates a selected word line WL identified by a received row address for its corresponding memory bank. Each one of the plurality of column decoders 131 to 134 activates a selected bit line BL identified by a received column address. Controller 140 comprises various control circuitry commonly understood to control the operation of the semiconductor memory device implemented around chip 100.

Chip 100 also comprises a plurality of Input/Output (I/O) pads 170 arranged at the periphery of the internal circuitry. The plurality of I/O pads is adapted to receive and/or output various signals, such as a test signal, read/write data, address signals, command/control signals, etc.

When a row address is applied to I/O pads 170, one of the plurality of row decoders 121 to 124 corresponding to one of the plurality of memory banks 111 to 114 is selected and activated. The selected row decoder will then activate a word line WL identified in the row address from among the plurality of word lines WL.

When a command signal is applied to I/O pads 170, a command decoder (not shown) in controller 140 decodes the received command to produce certain internal control signals.

When a column address is applied through I/O pads 170, one of the plurality of the column decoders 131 to 134 is selected and activated. The selected column decoder will then activate a bit line BL identified in the column address from among the plurality of bit lines BL.

Thus, if an applied command is a read command, chip 100 is enabled to output read data stored in a memory cell MC corresponding to the selected word line WL and the selected bit line BL via I/O pads 170. The output read data may be provided to external circuitry through I/O pins (not shown) associated with I/O pads 170.

As noted above, the asynchronous access time tAA is one widely accepted indication of operating speed for a semiconductor memory chip. In the context of a read operation applied to a semiconductor memory chip, the asynchronous access time tAA may be defined as the time elapsing between receipt of a read command and a corresponding output of read data.

In FIG. 2, the delay (i.e., signal flight time from test input pad to test output pad) of an applied test signal delay through a test signal path 101 extending between an input I/O pad 180 receiving input test data (TDI) and an output test pad 190 providing output test data (TDO) and comprising a number of delay elements (e.g., D11 through D14) may be used to indicate a defined asynchronous access time tAA associated with the chip 100.

That is, asynchronous access time tAA is the time required for a read command applied at an I/O pad 170 to be received, decoded by controller 140 and corresponding internal control signals to be generated, and for a column address and row address is applied to the respective decoders by (e.g., column decoder 131 and row decoder 121) in order to select and activate a bit line BL, such that data stored in (e.g.,) a selected memory cell MC to be output at another I/O pad 170. In various embodiments of the invention, the test signal path provides a test signal delay commensurate with (e.g.,) the foregoing functions or some other collection of similarly related functions.

Thus, an asynchronous access time tAA may be arbitrarily defined in relation to a desired set of functionality, model execution of a read/write operation, etc. However, the development and use of a test signal path associated with a defined asynchronous access time tAA will be explained with reference to FIG. 2 in the context of a read operation.

A read command and a corresponding column address are applied through one or more of I/O pads 170. Multiple data bits identifying the read command and column address are commonly applied in parallel through a plurality of I/O pads 170. The read command and column address might be applied through different or common I/O pads 170. The location of I/O pads 170 receiving the read command and column address may vary according to design of the semiconductor memory chip.

Various circuits of the semiconductor memory device operate in response to the read command as decoded with controller 140 including a selected column decoder (e.g.,) 131 which also operates in response to the column address in order to select a bit line BL associated with a memory cell storing the requested read data. Among the I/O pads 170 used to receive the read command and column address, a “farthest input” I/O pad 170 may be identified. This is the I/O pad 170 located the greatest physical distance (or greatest signal delay distance) from controller 140 and/or column decoder 131 and receiving the “last bit” of data within the read command or column address. The relevance of the last bit will be understood by those skilled in the art, as commonly applied read commands and/or column addresses may be communicated over a number of data transmission cycles defining a data frame for a data packet including the read command and/or column address. Thus, the term “last bit” refers to the last bit of a data signal required for operation of a circuit within the semiconductor memory device in relation to the read operation. By determining a “last bit” applied at a “farthest input” I/O pad, a starting point may be determined for the asynchronous access time, and/or a starting point for the corresponding test signal path may be identified. For example, in FIG. 2, it is assumed that the farthest input I/O pad relative to (randomly selected) column decoders 131 through 134 is the left lower most I/O pad 171.

In addition to the operation of controller 140 and column decoder 131, a selected row decoder (e.g.,) 121 must activate a word line WL from among the plurality of word lines WL in response to a received bank address. The bank address and/or row address may be applied to die 100 in the same data packet as the read command and/or the column address or in a related data packet. Thus, any reasonable collection of command data and/or address data, including row address and/or column address, will be referred to hereafter as “a command/address (C/A) packet.” In this use, the term packet should not be given an overly wooden interpretation mandating a defined data frame or multiplexed C/A data bits. Rather, any coherent collection of C/A data reasonably necessary to effect the desired operation (e.g., a read operation) in the semiconductor device may be a C/A packet. (In the context of a write operation the command/address packet may also include write data to form a C/A/W packet. Alternately, write data may be separately provided).

Returning to the working example of a read operation, a row address must typically be applied before activation of a selected bit line BL by column decoder 131. In response to the internal signals generated by controller 140, read data stored in the designated memory cell MC is applied to a data output path associated with column decoders 131 and the selected bit line BL. The read data is passed to one or more output I/O pad(s) 170.

The read data may be provided as an output data packet using a plurality of I/O pads 170. Similarly to the determination of a farthest input I/O pad 170, a farthest output I/O pad 170 may be determined for the particular configuration of the semiconductor memory device. The last bit of read data output by the semiconductor memory device at a farthest output I/O pad may be used to determine the asynchronous access time and its corresponding path and delay element characteristics.

Similarly, as illustrated in FIG. 2, a memory cell MC designated by a selected word line WL and bit line BL may be identified as “the farthest memory cell” MC in relation to the overall operation of the semiconductor memory device. The farthest memory cell MC will be a memory cell requiring the longest “read delay time” between application of the internal control signals, the word line signal and bit line signal to obtain stored read data. The read delay time will vary with the particular operation of memory bank 111, controller 140, row decoder 121, and column decoder 131, as well as the physical relationship (i.e., signal line length) between the memory cell and the farthest output I/O pad. Accordingly, since the asynchronous access time tAA should be based on all worse case assumptions, the farthest memory cell MC is used to calculate the test signal path.

As shown in FIG. 2, an exemplary test signal path indicative of the asynchronous access time for die 100 of the semiconductor memory chip may be implemented using a plurality of path segments arranged in the X and Y axes, where X and Y are any two orthogonally related axes. However, unlike the rather large conventional measuring circuit which is arranged around a central die region, many if not all of the various test signal path segments are arranged across the central die region largely, but not completely, occupied by circuitry necessary to the functionality of the semiconductor memory device. The phrase “an interior test signal path segment” is used to denote a test signal path segment substantially disposed with the central region of a semiconductor memory chip outside of the peripheral regions. An interior test signal path segment will generally be formed proximate constituent portions of the internal circuitry implementing the basic functionality of the semiconductor memory chip, (i.e., read/write operations). For example, in the illustrated example of FIG. 2 all interior test signal path segments are disposed between vertically or horizontally adjacent ones of the plurality of memory banks 111-114.

Thus, a first test signal path segment (line 11) extends in the X-axis direction and has a horizontal length greater than the horizontal length of the circuitry associated with memory bank 111 including row decoder 121. A second test signal path segment (line 12) extends in the Y-axis direction and has a vertical length greater than the vertical length of the circuitry associated with memory bank 111, including column decoder 121. Similarly, a third test signal path segment (line 13) extends in the Y-axis direction and has a vertical length greater than the vertical length of the circuitry associated with memory bank 112 including column decoder 132, and a fourth test signal path segment (line 14) extends in the X-axis direction and has a horizontal length greater than the horizontal length of the circuitry associated with memory bank 112, including column decoder 122. Stated in other terms, the first and fourth test signal path segments (line 11 and line 14) are disposed between horizontally adjacent memory banks and the second and third test signal path segments (line 12 and line 13) are disposed between vertically adjacent memory banks. Clearly, these test signal path segments are “interior” test signal path segments in contrast to the conventional layout of the signal path segments implementing a measuring circuit.

As may be seen from the foregoing, the layout of test signal path segments mimics the access signal lines associated with a memory cell MC in any one of memory banks 111 to 114, and includes at least two segments arranged in the X-axis direction and two segments arranged in the Y-axis direction. That is, the test signal path used to develop the asynchronous access time (tAA) for the semiconductor memory device of FIG. 2 includes a very sympathetic arrangement path segments relative to the flow of various C/A/ signals operative within a read operation accessing data stored in a memory cell contained in one of memory banks 11 through 114.

A measuring circuit 102 may be implemented in relation to test signal path 101. To do this in the working example of FIG. 2, the first test signal path segment, line 11, comprises a first delay element D11, the second test signal path segment, line 12, comprises a second delay element D12, the third test signal path segment, line 13, comprises a third delay element D13, and the fourth test signal path segment, line 14 comprises a fourth delay element D14. Input test data TDI applied to test input pad 180 by an external test device is delayed by a predetermined time determined by the sum of the first through fourth test signal path segments, and is ultimately output at test output pad 190 as the output test data TDO.

Each of the first through fourth delay elements (D11-D14) may be implemented using a number of delay components (e.g., inverters). The total number of the delay elements in the first through fourth delay elements (D11-D14) will be determined by the particular configuration of the semiconductor memory chip as well as the operating characteristics of its constituent circuitry. That is, the asynchronous access time associated with the semiconductor memory chip, including (e.g.,) the operation of controller 140, row decoder 121 and columns decoder 131, may be modeled by the corresponding provision of delay components in the respective delay elements. For this reason, the actual number and arrangement of the delay elements associated with the test signal path in the measuring circuit according to an embodiment of the invention will be determined in relation to the specific configuration and operating characteristics of the semiconductor memory chip.

In certain embodiments of the invention, a prescribed asynchronous access time tAA may be indicated by a fixed temporal relationship with a total delay time through the test signal path. This total delay time is equal to the sum of signal flight time through the first through fourth test signal path segments including any delay elements. (Note, that the number and arrangement of delay elements need not be related to the number of test signal path segments). Thus, for example, a 2 second asynchronous access time tAA may be indicated by a 1 second delay between test input data (TDI) application at input test pad 180 and test output data (TDO) provision at output test pad 190, or a ratio of 2:1.

Measuring circuit 102 of FIG. 2 is configured to correspond with the actual asynchronous access time path within the semiconductor memory chip, and because the test signal path segments are interior in nature instead of peripheral, measuring circuit 102 provides a more accurate indication of the asynchronous access time. Therefore, measuring circuit 102 of FIG. 2 has similar characteristics to those actually defining the asynchronous access time path within the semiconductor memory chip and is similarly configured with delay elements (D11-D14) and test signal path segments being sympathetically laid out across die 100.

A corresponding method of measuring the operating speed of the semiconductor memory device using measuring circuit 102 of FIG. 2 may be similar to the conventional method described in FIG. 1. That is, low frequency test input data (TDI) is applied to the semiconductor memory chip at a designated one or more I/O pads 170. The time delay until corresponding test output data (TDO) becomes apparent at a designated one or more I/O pads 170 is then measured. The total delay through the measuring circuit 102 is then compared to (or conditioned by) a correlation formula correlating the measured operating speed indicated by measuring circuit 102 with the actual operating speed for the semiconductor memory chip. Once appropriate delay elements have been defined in relation to a defined test signal path and a prescribed asynchronous access time tAA, all similar semiconductor memory chips manufactured thereafter may be tested using a measuring circuit according to an embodiment of the invention.

Of course, the configuration and structure of the semiconductor memory chip shown in FIG. 2 is merely exemplary. Different memory bank layouts, I/O pad layouts, and peripheral circuit layouts may be tested with improved accuracy in similar fashion using the dictates of the present invention.

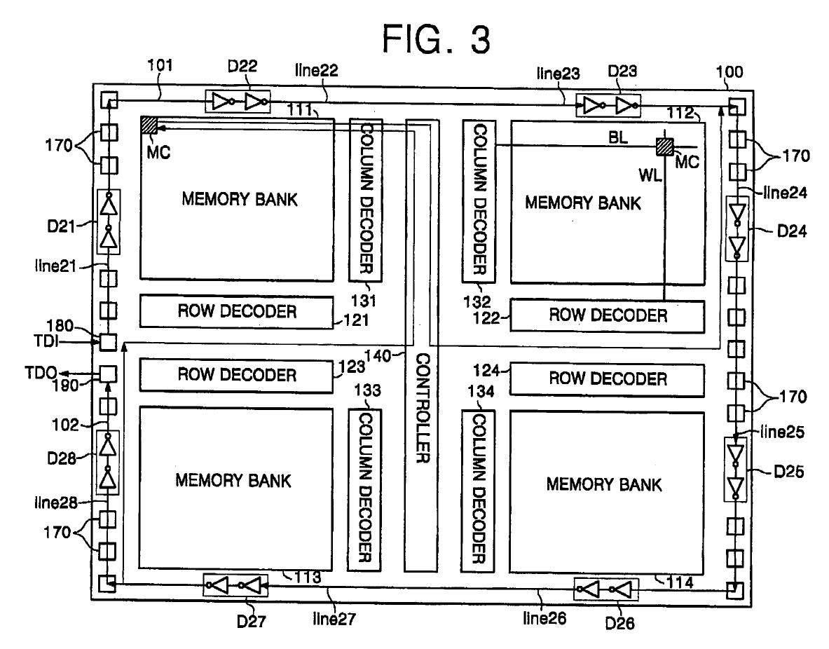

FIG. 3 is a schematic diagram illustrating a die of a semiconductor memory chip incorporating a measuring circuit according to another embodiment of the invention. The die of the semiconductor memory chip of FIG. 3 has a similar configuration to the chip 100 of FIG. 2 except for the configuration of measuring circuit 102.

Here, instead of being implemented using only interior test signal path segments, measuring circuit 102 is implemented using one or more exterior test signal path segments. That is, instead of running test signal path segments (lines 21 through 28) between adjacent memory banks or similar internal circuitry, test signal path 101 is laid out around the internal circuitry.

Here again, the X-axis (horizontal) and Y-axis (vertical) segments are sympathetically laid out in relation to the actual signal lines used to access stored data.

Also as suggested by the embodiment shown in FIG. 3, measuring circuit 102 may be laid out below, wholly or in part, an arrangement of I/O pads 170 arranged at the periphery of the internal circuitry. This configuration may be particularly useful when testing chips 100 included within a multi-layer structure. Such devices may not make use of the plurality of I/O pads 170 in order to avoid unnecessary delay or possible distortion to C/A and data signals. For this reason, it may be prudent to arrange measuring circuit 102 below the plurality of I/O pads 170 (i.e., on a bottom die surface, in a lower metallization layer, etc.). Since measuring circuit 102 is only used during testing, C/A or data signals applied to the plurality of I/O pads 170 will not be delayed or distorted by measuring circuit 102 during normal operation of the semiconductor memory chip.

Measuring circuit 102 of FIG. 3 is connected between test input pad 180 and test output pad 190 located on the same side of chip 100, although the location and relative disposition of either the test input pad 180 or test output pad 190 may be changed according to design requirements and in relation to the implementation of an acceptable test signal path corresponding to a defined asynchronous access time.

Similar to FIG. 2, each of the first to eighth test signal path segments D21 to D28 includes a defined delay element, but this correlation is only exemplary. The total number of delay elements and their respective delay characteristics will be determined in light of a delay time necessary to accurately model the defined asynchronous access time according to the structure and configuration of the semiconductor memory chip whose operating speed is being measured.

Otherwise, the use and operation of measuring circuit 102 in the embodiment of FIG. 3 is similar to that of the measuring circuit 102 in FIG. 2.

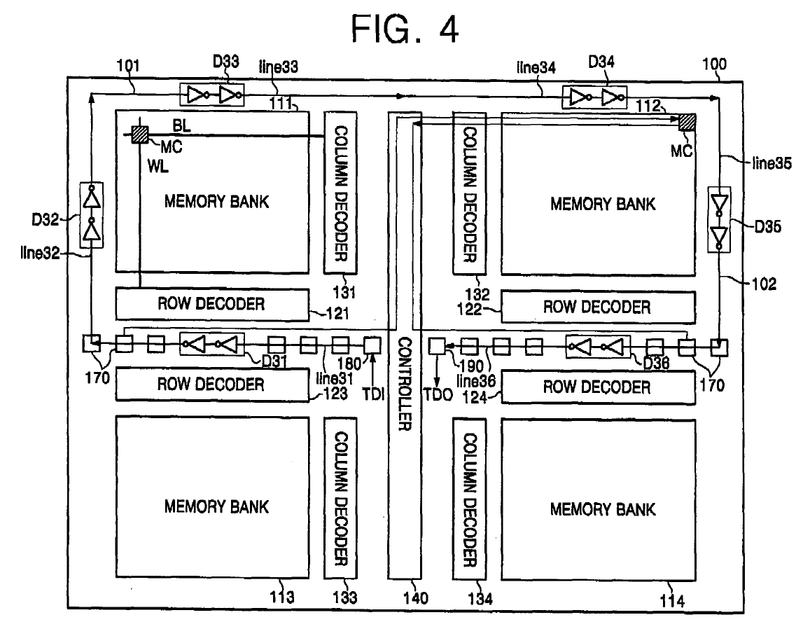

FIG. 4 is a schematic diagram illustrating a semiconductor memory chip 100 incorporating a measuring circuit 102 according to another embodiment of the invention. In FIG. 4, a mix of interior test signal path segments and exterior test signal path segments is used to implement measuring circuit 102 between test input pad 180 and test output pad 190 amongst I/O test pads 170. Of note, the I/O pads 170 of the embodiment shown in FIG. 4 are not arranged on the periphery of the internal circuitry implementing the semiconductor memory chip, but are considered “interior I/O pads” since they are arranged between the internal circuitry.

Due to developments in semiconductor device packaging technology certain lead-on-chip (LOC) techniques may be used in which a lead frame crosses over chip 100 to connect with centrally disposed I/O pads 170. Thus, interior I/O pads may be associated with measuring circuit 102. Such interior I/O pads 170 allow the overall size of the ultimate semiconductor memory device to be reduced, and I/O pads 170 may be arranged with greater flexibility.

Otherwise, the description of and the possible modifications to the embodiment illustrated in FIG. 4 are similar to those already presented in relation to FIGS. 2 and 3.

As described above, a circuit measuring the actual operating speed of a semiconductor memory chip according to an embodiment of the invention comprises a test signal path including a plurality of delay elements collectively providing a test signal delay indicative of a defined asynchronous access time. Various forms of test signals (e.g., data packet, parallel data, single signal line, etc.) may be applied in this regard. In this manner, accurate testing of a semiconductor memory chip may be conducted at the wafer level.

What is claimed is:

1. A circuit measuring the operating speed of a semiconductor memory chip in relation to a defined asynchronous access time, wherein the semiconductor memory chip comprises internal circuitry and the circuit comprises:
a test signal path extending between a test input pad and a test output pad, wherein the test signal path comprises a plurality of test signal path segments and at least one delay element associated with at least one of the plurality of test signal path segments, such that a delay time for a test signal communicated through the test signal path is indicative of an actual operating speed of the semiconductor memory chip in relation to the defined asynchronous access time, and
wherein each one of the plurality of test signal path segments is either an interior test signal path segment or an exterior test signal path segment.

2. The circuit of claim 1, wherein the test input pad and the test output pad are disposed on opposite peripheral sides of the semiconductor chip.

3. The circuit of claim 1, wherein the internal circuitry comprises a plurality of memory banks, and each one of the plurality of test signal path segments is an interior test signal path segment substantially disposed between adjacent ones of the plurality of memory banks.

4. The circuit of claim 1, wherein the at least one delay element comprises a plurality of delay elements each respectively associated with one of the plurality of test signal path segments.

5. The circuit of claim 1, wherein each one of the plurality of delay elements comprises multiple series connected delay components.

6. The circuit of claim 5, wherein each one of the delay components is an inverter.

7. The circuit of claim 1, wherein the internal circuitry comprises a plurality of memory banks and each one of the plurality of test signal path segments is an exterior test signal path, such that the test signal path is disposed around the plurality of memory banks.

8. The circuit of claim 7, wherein the test input pad and the test output pad are disposed on the same side of the semiconductor memory chip.

9. The circuit of claim 7, wherein the test signal path is disposed below at least a portion of a plurality Input/Output (I/O) pads arranged at the periphery of the semiconductor memory chip.

10. The circuit of claim 9, wherein the plurality I/O pads is arranged substantially surrounding the internal circuitry and the test signal path is disposed below the arrangement of I/O pads to substantially circumscribe the internal circuitry.

11. The circuit of claim 1, wherein the internal circuitry comprises a plurality of memory banks, and the semiconductor memory chip further comprises a plurality of Input/Output (I/O) pads, wherein at least a portion of the plurality of I/O pads is disposed between adjacent ones of the plurality of memory banks.

12. The circuit of claim 11, wherein at least one of the plurality of test signal path segments is an interior test signal path segment disposed below at least a portion of the plurality of I/O pads.

13. The circuit of claim 12, wherein at least one of the plurality of test signal path segments is an exterior test signal path segment connected to the interior test signal path segment.

14. The circuit of claim 1, wherein the measured delay time is proportional to the asynchronous access time path.
